(19) United States
(12) Patent Application Publication
(10) Pub. No.: US 2026/0091265 A1
(43) Pub. Date: Apr. 2, 2026

(54) ADAPTIVE PACE OF PLAY SYSTEM FOR GOLF COURSE

(71) Applicant: Textron Inc., Providence, RI (US)

(72) Inventors: Haley Ann Lind, Ford Mill, SC (US); Shayne Evan Rimer, NORTH AUGUSTA, SC (US)

(73) Assignee: Textron Inc., Providence, RI (US)

(21) Appl. No.: 18/899,954

(22) Filed: Sep. 27, 2024

(51) Int. Cl. A63B 24/00

(52) U.S. Cl. CPC A63B 24/0021; A63B 2024/0025; A63B 2024/0056; A63B 2220/12

(57) ABSTRACT

A pace of play system for a golf course includes one or more processing circuits. The one or more processing circuits are configured to acquire a plurality of past parameters regarding the golf course, acquire a plurality of current parameters relating to the golf course, and estimate a pace of play for one or more golfers playing the golf course based on the plurality of past parameters and the plurality of current parameters.

### BACKGROUND

Pace of play is an important statistic for a golf course to accurately determine and monitor. Knowledge of pace of play helps identify groups of golfers that are playing slow and facilitate taking corrective actions, facilitate tee-sheet optimization, etc. to make the golf course more efficient, more profitable, and, overall, more enjoyable for the golfers.

### SUMMARY

One embodiment relates to a pace of play system for a golf course. The pace of play system includes one or more processing circuits. The one or more processing circuits are configured to acquire a plurality of past parameters regarding the golf course, acquire a plurality of current parameters relating to the golf course, and estimate a pace of play for one or more golfers playing the golf course based on the plurality of past parameters and the plurality of current parameters.

Another embodiment relates to a pace of play system for a golf course. The pace of play system includes a non-transitory computer-readable medium having instructions stored thereon that, when executed by one or more processors, cause the one or more processors to acquire a plurality of past parameters regarding the golf course, acquire a plurality of current parameters relating to the golf course, and estimate a pace of play for one or more golfers playing the golf course based on the plurality of past parameters and the plurality of current parameters.

Still another embodiment relates to a pace of play system for a golf course. The pace of play system includes a non-transitory computer-readable medium having instructions stored thereon that, when executed by one or more processors, cause the one or more processors to acquire a plurality of past parameters regarding the golf course, acquire a plurality of current parameters relating to the golf course, estimate a pace of play for one or more golfers playing the golf course based on the plurality of past parameters and the plurality of current parameters, and determine at least one of an updated setup for the golf course, a shotgun start recommendation, or an adjustment to a tee sheet for the golf course based on the pace of play. Each of the plurality of past parameters and the plurality of current parameters includes at least two of a course setup of the golf course, an environmental condition at the golf course, a golf cart regulation at the golf course, real-time statistics associated with the one or more golfers, a profile associated with the one or more golfers, an event occurring at the golf course, or a walker versus rider status of the one or more golfers.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a fleet monitoring and control system including a plurality of the vehicles of FIG. 1, according to an exemplary embodiment.

FIG. 4 is a schematic block diagram of a system included in the fleet monitoring and control system of FIG. 3, according to an exemplary embodiment.

FIG. 5 is a schematic view of a portion of a golf course, according to an exemplary embodiment.

FIG. 6 is a flow diagram of a method for determining adaptive pace of play using a machine learning model, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

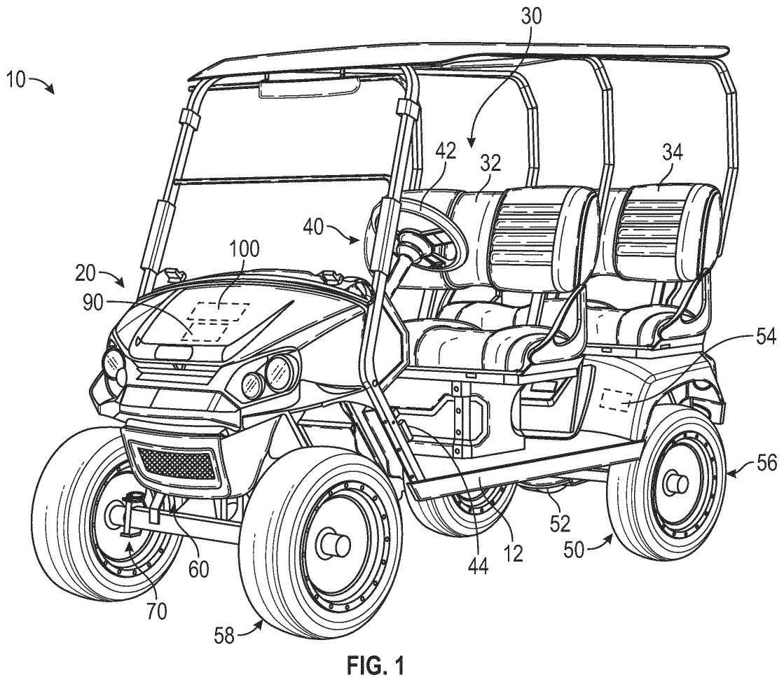

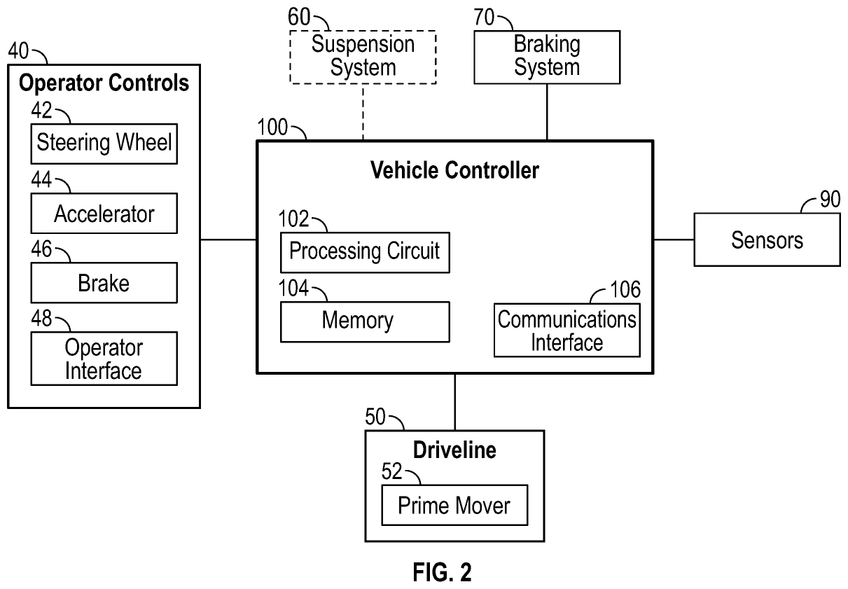

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Fleet Monitoring and Control System

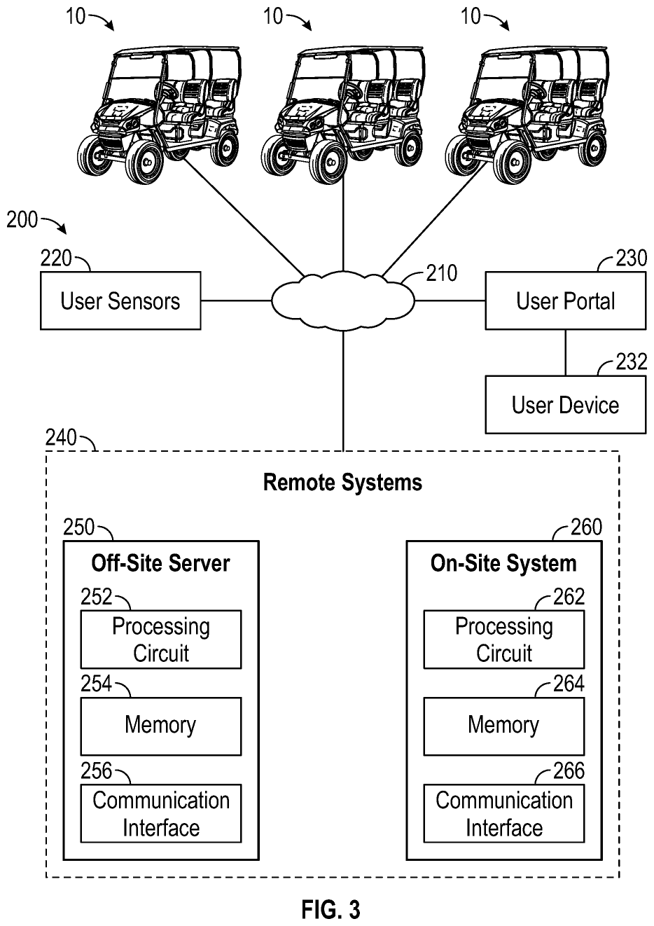

As shown in FIG. 3, a monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Adaptive Pace of Play

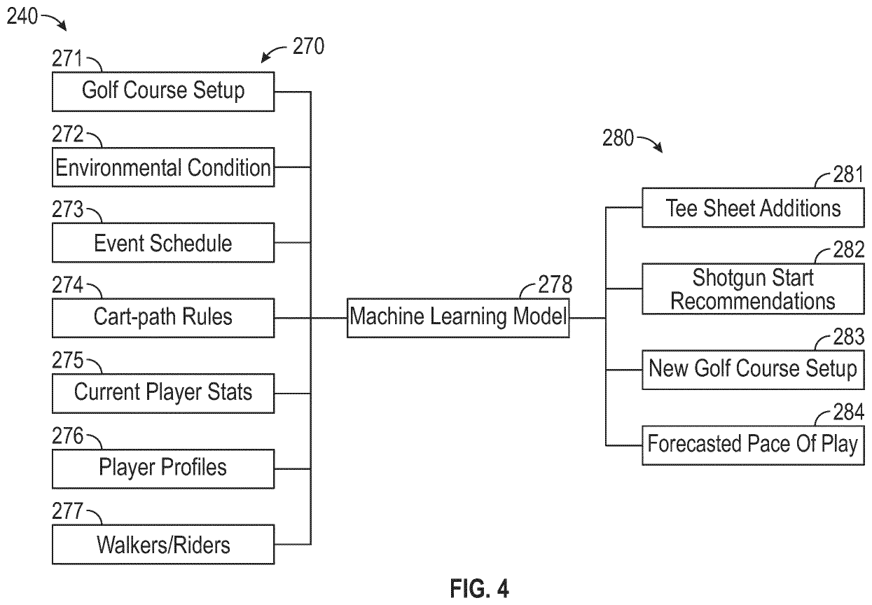

According to an exemplary embodiment, the fleet monitoring and control system 200, including the vehicle controller 100, the user sensors 220, the user portal 230, and the remote systems 240, is configured to facilitate estimating a pace of play on a golf course and performing various operations to improve/enhance a configuration of a golf course based on the pace of play. Further, it should be understood that any of the functions or processes described herein with respect to the fleet monitoring and control system 200 may be performed by the vehicle controller 100 and/or the remote systems 240. By way of example, data collection may be performed by the vehicle controller 100 and data analytics may be performed by the vehicle controller 100. By way of another example, data collection may be performed by the vehicle controller 100 and data analytics may be performed by the remote systems 240. By way of yet another example, data collection may be performed by the vehicle controller 100, a first portion of data analytics may be performed by the vehicle controller 100, and a second portion of data analytics may be performed by the remote systems 240. By way of still another example, a first portion of data collection may be performed by the vehicle controller 100, a second portion of data collection may be performed by the remote systems 240, and data analytics may be performed by the vehicle controller 100 and/or the remote systems 240. The adaptive pace of play will be described herein in the context of FIG. 4-6.

As shown in FIG. 4, an exemplary schematic block diagram of the remote systems 240 is shown. The remote systems 240 are configured to apply two or more inputs, shown as inputs 270, to a machine learning model, shown as machine learning model 278, and provide one or more outputs, shown as outputs 280, generated by the machine learning model 278. As described in greater detail below, the inputs 270 include past parameters regarding the golf course and current parameters relating to the golf course. In this way, the machine learning model 278 is trained to estimate a pace of play and generate the outputs 280 based on the past parameters and the current parameters. In some embodiments, the machine learning model 278 is part of the off-site server 250. Alternatively or additionally, the machine learning model 278 is part of the on-site system 260.

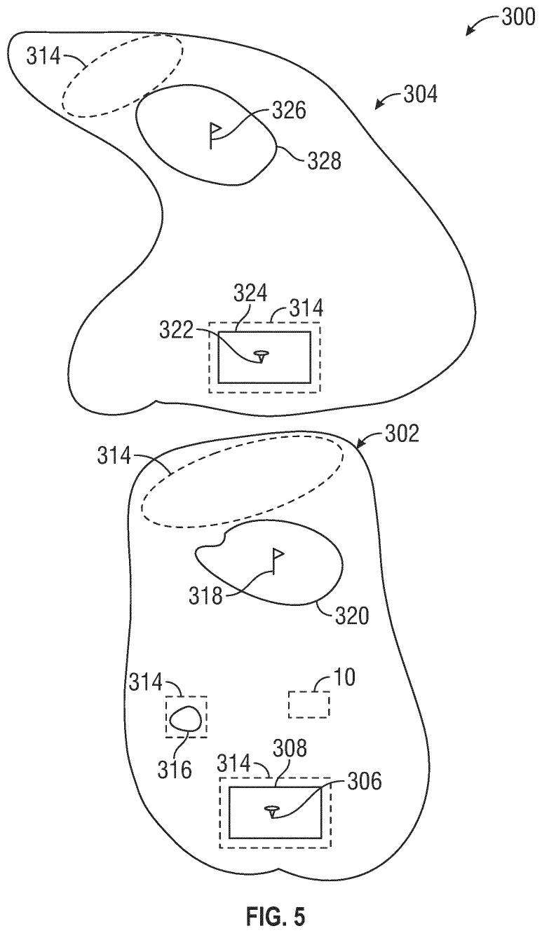

As shown in FIG. 4, the inputs 270 include a course setup of a golf course, shown as golf course setup 271. As an example, the golf course setup 271 may refer to the configuration of golf course 300 shown in FIG. 5. As shown in FIG. 5, the golf course 300 includes one or more holes, shown as first hole 302 and second hole 304. The first hole 302 of the golf course 300 includes a tee, shown as first tee 306, a tee box, shown as first tee box 308, a plurality of geofences, shown as geofences 314, one or more hazards (e.g., a sand trap, a water hazard, woods, fescue, non-playable area, area under repair, etc.), shown as hazard 316, a pin, shown as first pin 318, the vehicle 10, and a green, shown as first green 320. The geofences 314 include a tee box geofence surrounding the first tee box 308, a green geofence proximate the first green 320, and/or a hazard geofence (e.g., a geofence 314 surrounding the hazard 316, etc.). The second hole 304 of the golf course 300 includes a tee, shown as second tee 322, a tee box, shown as second tee box 324, the geofences 314, a pin, shown as second pin 326, and a green, shown as a second green 328. In other embodiments the golf course 300 includes more than two holes (e.g., a nine-hole course, an eighteen-hole course, etc.), more than two tees, more than two pins, more than two putting greens, more than one hazard, more than two tee boxes, and more than one vehicle 10.

In general, pace of play monitoring and reporting includes detecting or determining the location of a golf cart (e.g., the vehicle 10, etc.), and recording time stamps of when the golf cart enters and exits each of various geofences (e.g., the geofences 314). The differences between time stamps of entering and exiting the geofences are used to determine the pace of play for the respective hole (e.g., the difference between a timestamp of the vehicle 10 entering the tee geofence 314 and the timestamp of the vehicle 10 exiting the green geofence 314, etc.). The timestamps of the golf cart entering and leaving the geofences 314 can then be analyzed to determine the pace of play for the current hole. The pace of play for the respective hole becomes a part of the historical data that is accessible by the control system. Pace of play monitoring and reporting is described in greater detail in U.S. patent application Ser. No. 18/406,566, filed Jan. 8, 2024, which is incorporated herein by reference in its entirety.

Therefore, in some instances, the golf course setup 271 includes pin positions of the first pin 318 and/or the second pin 326. Additionally or alternatively, the golf course setup 271 includes tee positions of the first tee 306 and/or the second tee 322. According to exemplary embodiments, the pin positions and/or the tee positions are acquired from GPS devices (e.g., a user sensor 220, a hand-held TruPin GPS device offered by E-Z-GO® used by a groundskeeper of the golf course 300, a vehicle GPS of the vehicle 10, etc.) positioned or positionable proximate the pins (e.g., the first pin 318, the second pin 326) and/or the tees (e.g., the first tee 306, the second tee 322), respectively. In some embodiments, the pin positions and/or the tee positions are acquired from a user portal (e.g., user portal 230) accessible via a user computing device (e.g., user device 232). In some embodiments, the pin positions and/or the tee positions are acquired at the beginning of each day when the golf course 300 sets the locations of the first pin 318, the second pin 326, the first tee 306, and the second tee 322 to obtain an accurate recordation of the pin positions and/or the tee positions for that day. In this way, the pin positions and/or the tee positions become a part of the historical data (e.g., past parameters) regarding the golf course 300 that is later accessible by the remote systems 240 and/or the machine learning model 278 (e.g., during step 402 of method 400, as described below).

According to some embodiments, the acquired pin positions and/or the tee positions are accurate within one yard or less of an actual location of the pin positions and/or the tee positions. The tee positions impact the pace of play because the tee position impacts the distance a golfer must drive the ball during a tee shot (e.g., a first shot of the hole, etc.). The tee shot is important for attempting to achieve maximum distance while also maintaining accuracy, and often sets up subsequent shots for the hole, which influences overall strategy and outcome of the hole. For example, a tee position where the golfer must drive the ball farther, or a tee position that requires the golfer to need more strokes to complete the hole increases the total time spent on the hole and, therefore, slows the pace of play. The pin position impacts the pace of play because the pin position may alter the number of putts required for a golfer to complete the hole (e.g., more difficult pin positions lead to a higher number of putts and a slower pace of play).

According to some implementations, the golf course setup 271 includes a desired pace of play for the golf course. In some embodiments, the desired pace of play refers to a pace of play for the golf course 300 in its entirety (e.g., 4 hours, 5 hours, etc.). Alternatively or additionally, the desired pace of play refers to a pace of play corresponding to each hole on the golf course 300 (e.g., the first hole 302, the second hole 304, etc.). For example, the desired pace of play for the first hole 302 may be 15 minutes, while the desired pace of play for the second hole 304 may be 12 minutes (e.g., if the first hole 302 is a par-four and the second hole 304 is a par-three, etc.).

In some instances, the golf course setup 271 includes terrain characteristics of a terrain about the golf course. In some embodiments, the terrain includes the hazard 316 (e.g., a sand trap, a water hazard, woods, fescue, non-playable area, area under repair, etc.). Where the terrain refers to the hazard 316, the terrain characteristics refer to a position of the hazard 316 (e.g., a distance of the hazard 316 from a tee, a distance of the hazard 316 from a green, a position of the hazard with respect to a fairway, etc.) and/or a dimension of the hazard 316 (e.g., a diameter of a sand trap, a diameter of a water hazard, a length of the fescue, a number of trees in the woods, etc.). In some instances, the terrain characteristics of the terrain impact the pace of play at the golf course 300 and/or for a specific hole (e.g., the first hole 302, the second hole 304, etc.). For example, where a hazard 316 is proximate to the green, golfers may be more likely to encounter the hazard 316 (e.g., a golf ball lands in the water, the sand trap, the woods, etc.), which slows the pace of play because it takes more time to look for the golf ball, to determine a drop location if the golf ball is unplayable (e.g., lost in the water or the woods, in a non-playable area, etc.), and/or successfully hit the ball out of the hazard 316 (e.g., from the sand trap). As another example, where the hazard 316 is fescue, a longer length of the grass may slow the pace of play because it takes more time to search for a lost ball in the longer grass than in a shorter grass.

As shown in FIG. 4, the inputs 270 include one or more environmental conditions (e.g., one or more soil conditions, one or more precipitation levels, one or more humidity levels, one or more visibility levels, one or more air quality indexes, one or more wind speeds, one or more UV indexes, etc.) of the golf course 300, shown as environmental condition 272. In some instances, the environmental condition 272 is received via a weather-related application programming interface (“API”). For example, the weather API may be configured to access meteorological data databases (e.g., the National Oceanic and Atmospheric Administration National Weather Service, etc.). In some embodiments, the environmental condition 272 is acquired from the sensors 90 (e.g., a temperature sensor to acquire current temperature information, a capacitive humidity sensor to acquire humidity levels, etc.). According to some embodiments, the environmental condition 272 also includes recorded measurements input to the remotes systems 240 from a vehicle operator via the operator interface 48 (e.g., the vehicle operator utilizes a soil sensor to acquire soil conditions such as moisture or salinity, etc.).

Once received, the environmental condition 272 becomes a part of the historical data (e.g., past parameters) regarding the golf course 300 that is later accessible by the remote systems 240 and/or the machine learning model 278. In some embodiments, the remote systems 240 and/or the machine learning model 278 accesses the environmental condition 272 in real-time (e.g., is it currently raining on any hole of the golf course 300, is rain currently in the forecast for tomorrow, etc.). In some instances, the environmental condition 272 impacts the pace of play at the golf course 300 by impacting golfer performance and a number of golfers on the golf course 300. For example, if the environmental condition 272 includes rain, golfer performance may worsen due to the rainy condition, which slows the pace of play. As another example, if the environmental condition 272 forecasts rain, fewer golfers may show up to the golf course 300 in expectation of being rained on while playing a round of golf, which may improve the pace of play (e.g., fewer golfers on the golf course 300, less bottle necks in play, etc.). As yet another example, high wind speeds may impact golfer shots, thereby, affecting pace of play (e.g., wind towards a pin may facilitate longer shots and quicker play, wind towards a tee box may cause shorter shots and slower play, lateral wind may accentuate a golfer's hook or slice causing more balls to go out of play or enter rougher areas and increase pace of play, etc.)

As shown in FIG. 4, the inputs 270 include whether an event is occurring at the golf course 300, shown as event schedule 273. The event schedule 273 includes events occurring at the golf course 300 such as a professional tournament, an amateur tournament, a junior tournament, a private outing, and/or a public outing or open play to the public. Events occurring at the golf course 300 may impact the pace of play by determining skill of the golfers on the golf course 300 and/or a number of golfers on the golf course 300. For example, if a professional tournament is occurring at the golf course 300, the pace of play may be faster than during an amateur tournament or a junior tournament with the same or similar number of golfers as the professional tournament. As another example, if a private outing is occurring at the golf course 300, there may be fewer golfers on the golf course 300 than during a public outing, which may improve the pace of play.

As shown in FIG. 4, the inputs 270 include a golf cart regulation at the golf course 300, shown as cart-path rules 274. In some embodiments, the cart-path rules 274 include a “cart-path-only rule” or a “normal” rule. The cart-path-only rule allows the vehicles 10 to only travel on the paved or dedicated paths around the golf course 300. For example, the cart-path-only rule may be implemented due to the environmental condition 272 (e.g., rain, frost, etc.) causing the golf course 300 to be wet. The normal rule allows the vehicles 10 to travel on any acceptable region of the golf course 300 during normal course conditions (e.g., on paths, fairways, etc., but not on tee boxes, greens, restricted areas, etc.). The cart-path rules 274 impact the pace of play at the golf course 300 by determining how quickly golfers navigate each hole and the golf course 300. That is, if the cart-path rules 274 implement a cart-path-only rule, the golfers take more time to navigate a hole/the golf course 300, which slows the pace of play. For instance, if a golfer's ball falls on the left-side of the fairway, but the cart-path runs along the right side of the fairway, the cart-path-only rule requires the golfer to walk across the fairway to hit the next shot. Under the normal rule, however, the golfer would be allowed to drive across the fairway to hit the next shot, which saves time and, therefore, improves pace of play.

As shown in FIG. 4, the inputs 270 include real-time statistics associated with one or more golfers playing the golf course 300, shown as current player stats 275. The current player stats 275 include a yardage reached by the one or more golfers during a previous shot, a location of a ball prior to and after the previous shot, and/or a time spent by the one or more golfers on a previous hole. In this way, the current player stats 275 are received as current parameters of the golf course 300, rather than past parameters (e.g., past statistics associated with the one or more golfers are reflected by the player profiles 276). The current player stats 275 may be used to determine a current pace of play of a respective golfer by identifying how quickly the golfer has been playing holes on the golf course 300. For instance, a high yardage reached during the previous shot, the location of the ball after the previous shot advancing the ball towards the green compared to the location of a ball prior to the previous shot, and a short amount of time spent on the previous hole each reveal that the golfer is playing at a fast pace of play.

As shown in FIG. 4, the inputs 270 include a profile associated with the one or more golfers playing at the golf course 300, shown as player profiles 276. The player profiles 276 include a handicap of the one or more golfers, an age of the one or more golfers, past statistics of the one or more golfers on the golf course 300 (e.g., a yardage reached by the one or more golfers, a location of a ball prior to and after a shot, a time spent by the one or more golfers on a hole, etc.) and/or a number of rounds of golf played by the one or more golfers on the golf course 300 and/or other golf courses (e.g., of similar difficulty, of harder difficulty, etc.). In some embodiments, the player profiles 276 include published information retrieved from an external source, such as the Official World Golf Rankings and/or the World Amateur Golf Rankings. The player profiles 276 become a part of the historical data regarding the golf course 300 that is later accessible by the remote systems 240 and/or the machine learning model 278. In this way, when a golfer plays a round of golf at the golf course 300, the remote systems 240 and/or the machine learning model 278 retrieve the player profile 276 corresponding to the golfer and use the information contained therein to estimate or forecast how long that it may take the golfer to play a round of golf (e.g., estimate the pace of play). For example, if the player profile 276 reveals at least one of a high handicap (e.g., 20), a young or old age (e.g., 8 years old, 75 years old, etc.), a short average yardage reached off tees (e.g., 80 yards, 120 yards, etc.), a long time spent on a hole (e.g., 20 minutes), or a small number of rounds of golf played in the golfer's career (e.g., five rounds), the player profile 276 may suggest that the golfer associated therewith plays at a slower pace than a golfer associated with a player profile 276 revealing at least one of a lower handicap (e.g., 2), a prime age (e.g., 25 years old, 35 years old, etc.), a longer average yardage reached off tees(e.g., 250 yards, 300 yards, 320 yards, etc.), a shorter time spent on a hole (e.g., 7 minutes), or a larger number of rounds of golf played in the golfer's career (e.g., 500 rounds).

As shown in FIG. 4, the inputs 270 include a walker versus rider status of the one or more golfers playing at the golf course 300, shown as walkers/riders 277. The walkers/riders 277 are identified by determining whether each of the one or more golfers is assigned to a golf cart (e.g., one of the vehicles 10) or not. For example, when a golfer checks-in for a tee time at the golf shop and/or bag room, golf course personnel may assign the golfer to a golf cart at that time. The walkers/riders 277 impact the pace of play at the golf course 300 because, generally, it takes more time to play a round of golf if a golfer is walking than if the golfer is riding in a vehicle 10. Therefore, if the walkers/riders 277 indicates that there are more walkers than riders on the golf course 300, the pace of play is expected to be slower than if there are more riders than walkers on the golf course 300.

As described above, the inputs 270 are applied to the machine learning model 278 to train the machine learning model 278, and well as to generate the outputs 280. As shown in FIG. 4, the outputs 280 include additions to a tee sheet, shown as tee sheet additions 281. That is, the machine learning model 278 identifies one or more gaps in the tee sheet for the golf course 300 based on an estimated pace of play of the golfers currently playing on the golf course 300 and/or scheduled to be playing on the golf course 300 (e.g., determined by the machine learning model 278 based on the various inputs 271-277). Then, the tee sheet is adjusted by adding one or more new golfers at a tee time and a hole location corresponding to the one or more gaps. For instance, if the player profiles 276 corresponding to a first group of golfers on the tee sheet suggest that the first group of golfers play faster than a second group of golfers behind the first group of golfers on the tee sheet, the tee sheet additions 281 may suggest adding the new golfers between the first group of golfers and the second group of golfers. As another example, if a group of four walkers are playing behind a group of four riders, the tee sheet additions 281 may suggest adding the new golfers between the group of walkers and the group of riders. In this way, the tee sheet additions 281 maximize a capacity of the golf course by adjusting the tee sheet to include as many golfers as possible while maintaining a desired pace of play (e.g., by filling in the identified gaps).

As show in FIG. 4, the outputs 280 include one or more recommendations, shown as shotgun start recommendations 282. The shotgun start recommendations 282 identify which golfers to group together and at which hole each group of golfers should start at on the golf course 300. In this way, each group of golfers is created such that a plurality of groups of golfers participating in the shotgun start are expected to play at roughly a same pace of play (e.g., based on the player profiles 276). Further, the hole that each group of golfers should start at on the golf course 300 is determined such that each of the groups of golfers plays a first hole in the round of golf (e.g., following the shotgun start) at roughly the same pace of play. For example, if a first group of golfers is expected to play at a slower pace of play than a second group of golfers, the shotgun start recommendations 282 may suggest that the first group of golfers start on an easier hole (e.g., with a shorter distance from the tee to the pin, with fewer hazards, etc., as reveled by the golf course setup 271) and the second group of golfers start on a more difficult hole (e.g., with a longer distance from the tee to the pin, with more hazards, etc., as revealed by the golf course setup 271).

As shown in FIG. 4, the outputs 280 include a suggested updates or changes to the setup of the golf course 300, shown as new golf course setup 283. The new golf course setup 283 may include suggestions or recommendations for a new tee position for the first tee 306 and/or the second tee 322. That is, the new tee position refers to a relocation of the first tee 306 and/or the second tee 322 relative to the position of the first tee 306 and/or the second tee 322 shown in FIG. 5. Similarly, the new golf course setup 283 may include suggestions or recommendations for a new pin position for the first pin 318 and/or the second pin 326. For instance, the new pin position refers to a relocation of the first pin 318 and/or the second pin 326 relative to the position of the first pin 318 and/or the second pin 326 shown in FIG. 5.

As another example, the new golf course setup 283 may include an adjustment to the terrain about the golf course 300. In such examples, the adjustment to the terrain may refer to (a) adding, removing, or moving a sand trap (e.g., the hazard 316), (b) increasing or decreasing a height of grass, (c) planting or cutting down trees (e.g., the hazard 316), etc. In instances where the machine learning model 278 acquires the desired pace of play for the golf course 300 from among the inputs 270 (e.g., from the golf course setup 271), as described above, the new golf course setup 283 includes an updated setup for the golf course 300 to substantially provide the desired pace of play. That is, the machine learning model 278 predicts the pace of play for the new golf course setup 283 (e.g., a predicted pace of play, etc.) and generates adjustments to the current setup to provide the new setup where the predicted pace of play is substantially equal to the desired pace of play. The new golf course setup 283 includes information on where one or more of the tee positions and one or more of the pin positions should be for each hole to achieve the desired pace of play. According to some instances, the new golf course setup 283 includes the adjustment to the terrain to achieve the desired pace of play. In some embodiments the new golf course setup 283 includes multiple different options of new tee positions, new pin positions, and/or adjustments to the terrain for achieving the desired pace of play (e.g., three different layouts for the tee positions and the pin positions to achieve the desired pace of play, three different hazards to adjust, etc.).

In some instances, the outputs 280 include a predicted pace of play, shown as forecasted pace of play 284. That is, the forecasted pace of play 284 refers to a predicted pace of play for a future point in time (e.g., over the next hour, for an upcoming afternoon, tomorrow, next week, etc.) based on the inputs 270. For example, the forecasted pace of play 284 over the next hour may be generated based on current and forecasted weather conditions for the next hour (e.g., environmental condition 272), current and previous performance of the golfers who will still be playing on the golf course 300 over the next hour (e.g., current player stats 275), past performance of golfers who will begin playing on the golf course 300 over the next hour (e.g., player profiles 276, etc.), and so on.

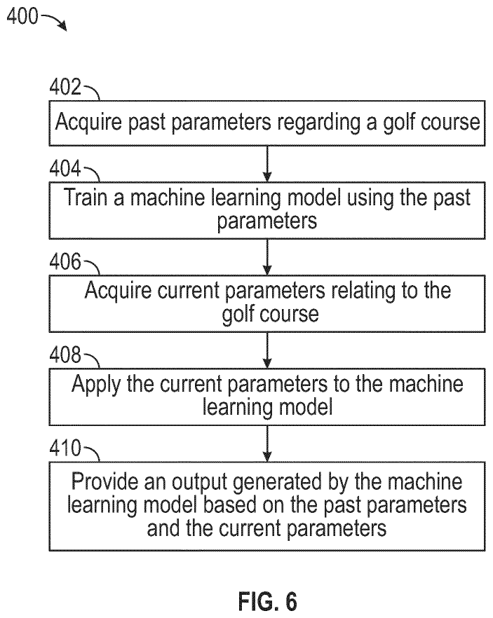

As shown in FIG. 6, a method 400 for determining an output (e.g., one of the outputs 280) using the machine learning model 278 and one or more of the inputs 270 of FIG. 4 is shown. In some embodiments, the method 400 is performed by the fleet monitoring and control system 200, the vehicle controller 100, and/or the remote systems 240.

At step 402, a control system (e.g., the fleet monitoring and control system 200, the vehicle controller 100, the remote systems 240, etc.) is configured to acquire (e.g., detect, record, collect, determine, etc.) past parameters regarding the golf course 300. The past parameters refer to the golf course setup 271, the environmental condition 272, the event schedule 273, the cart-path rules 274, the player profiles 276, and/or the walkers/riders 277 from a past point in time (e.g., a few hours ago, yesterday, last week, last month, last year, etc.). In some embodiments, where the past parameters include the environmental condition 272, the past parameters include past weather conditions at the golf course 300.

At step 404, the control system is configured to train the machine learning model 278 using the past parameters acquired at step 402. That is, training the machine learning model 278 using the past parameters includes identifying a pace of play resulting from the past parameters. For instance, the machine learning model 278 may be trained using past environmental conditions (e.g., environmental condition 272) to identify that certain weather conditions (e.g., rain, extreme heat, cold temperatures, etc.) correspond to a slower pace of play. In other words, the machine learning model 278 is trained using the past parameters to identify relationships between each of the inputs 270 and a pace of play (e.g., the relationships described above with reference to each of the respective inputs 270).

At step 406, the control system is configured to acquire current parameters relating to the golf course 300. The current parameters refer to the golf course setup 271, the environmental condition 272, the event schedule 273, the cart-path rules 274, the current player stats 275, the player profiles 276, and/or the walkers/riders 277 from a current point in time. For example, where the current parameters include the environmental condition 272, the current parameters may include a current weather condition and/or a forecasted weather condition at the golf course 300.

At step 408, the control system is configured to apply the current parameters acquired at step 406 to the machine learning model 278 that has been trained at step 404. Based on the training of the machine learning model 278 performed at step 404, the machine learning model 278 is trained to identify the relationships between each of the current parameters and the pace of play (e.g., based on the relationships between each of the inputs 270 and the pace of play identified during the training at step 404). In this way, the machine learning model 278 is configured to provide recommendations (e.g., the outputs 280) related to improving the pace of play based on the relationships between the current parameters and the pace of play.

In some embodiments, the machine learning model 278 also receives a baseline/average pace of play associated with each hole on the golf course 300 (e.g., determined using the geofences 314, as described above). Given the inputs 270 applied to the machine learning model 278, however, the machine learning model 278 is configured to predict how a baseline/average pace of play associated with each hole on the golf course 300 changes based on different scenarios created by the inputs 270. For example, the machine learning model 278 may determine how much longer, relative to the baseline/average pace of play, it takes to play a hole based on adverse environmental conditions, a cart-path-only rule, a number of golfers currently on the golf course 300, a pace of a preceding group, and so on. Then, the additional time is added to the baseline/average pace of play to estimate the actual pace of play for the hole given the inputs 270. In some embodiments, the machine learning model 278 is a linear regression model configured to estimate the pace of play as described.

At step 410, the control system is configured to provide an output generated by the machine learning model 278 based on the past parameters acquired at step 402 and the current parameters acquired at step 406. In some instances, prior to providing the output at step 410, the machine learning model 278 is configured to estimate a pace of play for one or more golfers playing the golf course 300 based on the past parameters acquired at step 402 and the current parameters acquired at step 406 (e.g., the forecasted pace of play 284). Then, based on the pace of play estimated by the machine learning model 278, the control system is configured to provide one or more additional outputs. In various embodiments, the one or more additional outputs provided at step 410 includes at least one of the tee sheet additions 281, the shotgun start recommendations 282, or the new golf course setup 283, as described above.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A pace of play system for a golf course, the pace of play system comprising:
one or more processing circuits configured to:
acquire a plurality of past parameters regarding the golf course;
acquire a plurality of current parameters relating to the golf course; and
estimate a pace of play for one or more golfers playing the golf course based on the plurality of past parameters and the plurality of current parameters.

2. The pace of play system of claim 1, wherein each of the plurality of past parameters and the plurality of current parameters includes at least two of a course setup of the golf course, an environmental condition at the golf course, a golf cart regulation at the golf course, real-time statistics associated with the one or more golfers, a profile associated with the one or more golfers, an event occurring at the golf course, or a walker versus rider status of the one or more golfers.

3. The pace of play system of claim 2, wherein the one or more processing circuits are configured to:
acquire a desired pace of play for the golf course; and
generate an updated setup for the golf course based on the plurality of past parameters and the plurality of current parameters to substantially provide the desired pace of play.

4. The pace of play system of claim 3, wherein the course setup includes pin positions of pins on the golf course and tee positions of tees on the golf course.

5. The pace of play system of claim 4, wherein the pin positions and the tee positions are acquired from GPS devices positioned or positionable proximate the tees and the pins.

6. The pace of play system of claim 4, wherein the pin positions and the tee positions are acquired from a user portal accessible via a user computing device.

7. The pace of play system of claim 4, wherein the updated setup for the golf course includes at least one of a new tee position for at least one of the tees or a new pin position for at least one of the pins.

8. The pace of play system of claim 3, wherein the course setup includes terrain characteristics of a terrain about the golf course.

9. The pace of play system of claim 8, wherein the updated setup for the golf course includes an adjustment to the terrain.

10. The pace of play system of claim 9, wherein the adjustment to the terrain includes at least one of (a) adding, removing, or moving a sand trap, (b) increasing or decreasing a height of grass, or (c) planting or cutting down trees.

11. The pace of play system of claim 2, wherein each of the plurality of past parameters and the plurality of current parameters includes the environmental condition, wherein the environmental condition for the past parameters includes a past weather condition at the golf course, and wherein the environmental condition for the current parameters includes at least one of a current weather condition or a forecasted weather condition at the golf course.

12. The pace of play system of claim 2, wherein the plurality of current parameters include the real-time statistics, and wherein the real-time statistics include at least one of a yardage reached by the one or more golfers during a previous shot, a location of a ball prior to and after the previous shot, or a time spent by the one or more golfers on a previous hole.

13. The pace of play system of claim 2, wherein the plurality of current parameters include the profile associated with the one or more golfers, and wherein the profile includes at least one of a handicap of the one or more golfers, an age of the one or more golfers, past statistics of the one or more golfers on the golf course, or a number of rounds of golf played by the one or more golfers.

14. The pace of play system of claim 2, wherein each of the plurality of past parameters and the plurality of current parameters includes the event occurring at the golf course, and wherein the event occurring at the golf course includes at least one of a professional tournament, an amateur tournament, a junior tournament, a private outing, or a public outing.

15. The pace of play system of claim 2, wherein each of the plurality of past parameters and the plurality of current parameters includes the walker versus rider status of the one or more golfers, and wherein the walker versus rider status of each of the one or more golfers is determined by identifying whether each of the one or more golfers is assigned to a golf cart or not.

16. The pace of play system of claim 1, wherein the one or more processing circuits are configured to provide a shotgun start recommendation for the golf course based on the pace of play, and wherein the shotgun start recommendation identifies which golfers to group together and at which hole each group of golfers should start at on the golf course.

17. The pace of play system of claim 1, wherein the one or more processing circuits are configured to:
determine, based on the pace of play, one or more gaps in a tee sheet for the golf course; and
adjust the tee sheet by adding one or more new golfers at a tee time and a hole location corresponding to the one or more gaps.

18. A pace of play system for a golf course, the pace of play system comprising:
a non-transitory computer-readable medium having instructions stored thereon that, when executed by one or more processors, cause the one or more processors to:
acquire a plurality of past parameters regarding the golf course;
acquire a plurality of current parameters relating to the golf course; and
estimate a pace of play for one or more golfers playing the golf course based on the plurality of past parameters and the plurality of current parameters.

19. The pace of play system of claim 18, wherein each of the plurality of past parameters and the plurality of current parameters includes at least two of a course setup of the golf course, an environmental condition at the golf course, a golf cart regulation at the golf course, real-time statistics associated with the one or more golfers, a profile associated with the one or more golfers, an event occurring at the golf course, or a walker versus rider status of the one or more golfers.

20. A pace of play system for a golf course, the pace of play system comprising:
a non-transitory computer-readable medium having instructions stored thereon that, when executed by one or more processors, cause the one or more processors to:
acquire a plurality of past parameters regarding the golf course;
acquire a plurality of current parameters relating to the golf course;
estimate a pace of play for one or more golfers playing the golf course based on the plurality of past parameters and the plurality of current parameters; and
determine at least one of an updated setup for the golf course, a shotgun start recommendation, or an adjustment to a tee sheet for the golf course based on the pace of play;
wherein each of the plurality of past parameters and the plurality of current parameters includes at least two of a course setup of the golf course, an environmental condition at the golf course, a golf cart regulation at the golf course, real-time statistics associated with the one or more golfers, a profile associated with the one or more golfers, an event occurring at the golf course, or a walker versus rider status of the one or more golfers.
